(19) United States
(12) Patent Application Publication
(10) Pub. No.: US 2026/0340111 A1
(43) Pub. Date: Oct. 29, 2026

(54) Safescript Malware Deobfuscation

(71) Applicant: CrowdStrike, Inc., Sunnyvale, CA (US)

(72) Inventor: Dmitry SEREBRENNIKOV, East Palo Alto, CA (US)

(73) Assignee: CrowdStrike, Inc., Sunnyvale, CA (US)

(21) Appl. No.: 19/188,446

(22) Filed: Apr. 24, 2025

(51) Int. Cl. G06F 21/53; G06F 21/54; G06F 21/56

(52) U.S. Cl. CPC G06F 21/53; G06F 21/54; G06F 21/564

(57) ABSTRACT

Safescript substitution greatly improves computer functioning. Many scripting languages are vulnerable to obfuscated malware. Safescript substitution, though, deobfuscates the malware by replacing a scripting command (such as cmdlet content) with safescript. The safescript represents a safe implementation of the cmdlet content that captures properties/parameters and calls without executing dangerous, obfuscated malware code. Safescript substitution allows safe, simulated execution of obfuscated scripts that rely on complex runtime behaviors. Safescript substitution thus ultimately reveals the true intent of the obfuscated script without risk of activation.

### BACKGROUND

The subject matter described herein generally relates to computers and to computer security and, more particularly, the subject matter relates to code parsing and to malware detection.

Many computers are exposed to malware and to other cybersecurity threats. It seems every day there is another cybersecurity hack that steals account passwords, business data, and personal information. Perhaps even more concerning is that cybercriminals are always devising new and ever-more sophisticated attacks. Most malware and other cybersecurity threats are cleverly obfuscated to evade detection.

### SUMMARY

Safescript malware deobfuscation greatly improves computer functioning. Many scripting languages are vulnerable to obfuscated malware. Safescript malware deobfuscation, though, reveals the malware that is hidden deep within scripting languages. The malware is deobfuscated by replacing cmdlet content with safescript. The safescript represents a safe implementation of the cmdlet content. The safescript, for example, captures properties and method calls without executing dangerous, obfuscated malware contained within the cmdlet content. Safescript substitution allows safe, simulated execution of obfuscated malware that relies on complex runtime behaviors. Safescript substitution thus reveals the true intent of the obfuscated malware without risk of activation.

### BRIEF DESCRIPTION OF THE SEVERAL VIEWS OF THE DRAWINGS

The features, aspects, and advantages of safescript malware deobfuscation are understood when the following Detailed Description is read with reference to the accompanying drawings, wherein:

FIG. 1 illustrates some examples of malware deobfuscation;

FIG. 2 illustrates some examples using scripting languages;

FIG. 3 illustrates more examples using Microsoft's POWERSHELL® scripting language;

FIG. 4 illustrates examples of simulated runtime execution;

FIG. 5 illustrates examples of abstract simulated execution;

FIGS. 6-8 illustrate more examples of malware deobfuscation;

FIGS. 9-10 illustrate examples of deobfuscation reporting;

FIG. 11 illustrates examples of maliciousness scoring;

FIGS. 12-14 illustrate examples of safescript substitution;

FIG. 15 illustrates examples of textual pattern matching;

FIG. 16 illustrates more examples of improved computer functioning;

FIG. 17 illustrates examples of natural language assessment;

FIGS. 18-20 illustrate examples of methods or operations that deobfuscate the malware; and

FIG. 21 illustrates a more detailed example of the operating environment.

### DETAILED DESCRIPTION

Some examples relate to deobfuscating malicious software (or malware) in command lines and process trees. As we know, nearly every day we read of another network hack, computer virus, or other cybersecurity threat. These cybersecurity threats often hide in the deep details of complicated computer code. That is, cyberattackers often hide, or obfuscate, their malware within the complicated computer code. It may take teams of expert threat hunters many minutes, or longer, to find the obfuscated malware hidden deep within computer code. By then, of course, the malware's damage is done.

A cybersecurity deobfuscation service, though, quickly catches and stops the obfuscated malware before damage is done. Before a computer executes computer code, the deobfuscation service reads the computer code and generates a much simpler and optimized version. The deobfuscation service, for example, replaces complicated computer lines of text with a much safer and simpler safescript. The safescript represents a safe implementation of commands and other text, albeit without malware. Once the command(s) is/are replaced with the safer and simpler safescript, the computer may simulate an execution of the safescript. So, even if the command contained hidden, obfuscated malware, the obfuscated malware is replaced with the safe and simple safescript. By replacing the obfuscated malware, the deobfuscation service emulates execution without the dangerous effects of the hidden malware. The deobfuscation service thus reveals the true intent of the obfuscated malware without risk of actual activation.

Safescript malware deobfuscation will now be described more fully hereinafter with reference to the accompanying drawings. Safescript malware deobfuscation, however, may be embodied in many different forms and should not be construed as limited to the examples set forth herein. These examples are provided so that this disclosure will be thorough and complete and fully convey safescript malware deobfuscation to those of ordinary skill in the art. Moreover, all the examples of safescript malware deobfuscation are intended to encompass both structural and functional equivalents thereof. Additionally, it is intended that such equivalents include both currently known equivalents as well as equivalents developed in the future (i.e., any elements developed that perform the same function, regardless of structure).

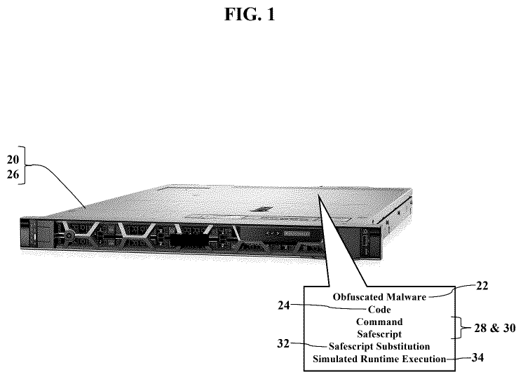

FIG. 1 illustrates some examples of malware deobfuscation. A computer system 20 detects a malware 22 that is cleverly hidden, or obfuscated, in computer programming code 24. FIG. 1 illustrates the computer system 20 as a server 26, which is commonly installed in many computer rooms and server farms. The computer system 20, though, may be any processor-controlled device, as later paragraphs will explain. If the server 26 executes the malware 22, the malware 22 causes the computer system 20 to perform unwanted/undesirable/abnormal/malicious activities (such as stealing/exfiltration of emails and passwords, ransomware lockup, and running botnets). In this example, though, the server 26 elegantly deobfuscates the malware 22. That is, the server 26 elegantly preprocesses the code 24 to reveal the presence of the malware 22. The server 26 inspects the code 24 for a known command 28 that may be susceptible to the obfuscated malware 22. The server 26 then identifies a safescript 30 that is related to the command 28. The safescript 30, for example, represents a safe implementation of the command 28, without the presence of the malware 22. The server 26 may then execute a safescript substitution 32 that substitutes the safescript 30 for the command 28 within the code 24. Then, once the command 28 has been replaced with the safescript 30, the server 26 may execute a safe, simulated runtime execution 34 of the code 24 using the safescript 30. The server 26, in other words, emulates execution of the code 24 without executing the dangerous, obfuscated malware 22 that may be contained within the command 28. The safescript substitution 32 thus reveals the true intent of the obfuscated malware 22 without risk of actual activation.

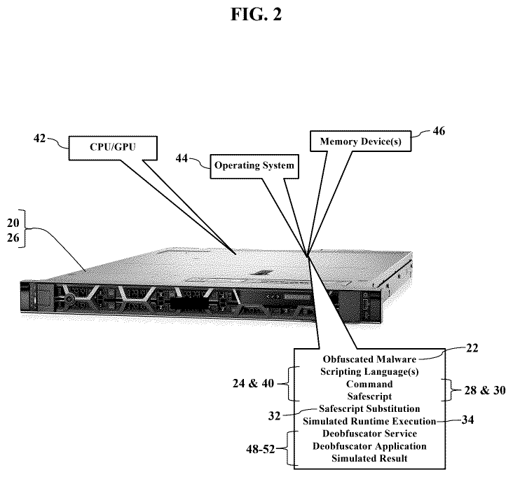

FIG. 2 illustrates some examples using scripting languages 40. The computer system 20 (again illustrated as the server 26) may be programmed to deobfuscate the malware 22 contained within the script commands 28. As the reader may know, the server 26 has a hardware processor with cores 42 (illustrated as “CPU/GPU”) that reads and executes an operating system 44 stored in a memory device 46. The server 26 may also store and execute one or more scripting languages 40 (such as Microsoft's POWERSHELL®, Microsoft's VISUAL BASIC® script, Oracle's JAVASCRIPT®, and Apple's APPLESCRIPT®). Whatever the scripting language 40, some of the commands 28 within the scripting language 40 may contain the obfuscated malware 22. Again, if the server 26 were to execute the command 28 containing the obfuscated malware 22, the computer system 20 may perform harmful activities.

Here, though, the server 26 provides a deobfuscator service 48. The deobfuscator service 48 deobfuscates, or reveals, the malware 22 that may be hidden within the script commands 28. The server 26 stores a deobfuscator application 50 in the memory device 46. When the hardware processor 42 executes the deobfuscator application 50, the deobfuscator application 50 helps provide the deobfuscator service 48. The deobfuscator application 50, for example, may be a software component (perhaps with an API) that provides functionality to the computer system/server 20/26. The deobfuscator application 50, for example, cooperates with the operating system 44 to safely deobfuscate the malware 22 by modifying the scripting language 40. The deobfuscator application 50 instructs or causes the server 26 to perform operations, such as identifying the script command 28 within the scripting language 40. The deobfuscator application 50 instructs or causes the server 26 to identify the safescript 30 that is related to the script command 28. The safescript 30 represents a safe implementation of the script command 28. The deobfuscator application 50 instructs or causes the server 26 to perform the safescript substitution 32, thus substituting the script command 28 for its corresponding safescript 30. The server 26, for example, may identify the script command 28, and its arguments, parameters, and other components. The server 26 may then cut the script command 28 from within the code/language 24/40 and paste/insert the safescript 30. Once the code/language 24/40 has been safely modified using the safescript substitution 32, the deobfuscator application 50 instructs or causes the server 26 to perform the simulated runtime execution 34 of the code 24 using the safescript 30. The server 26, in other words, emulates execution of the safely modified code/language 24/40. That is, because the script command 28 has been optimized (such as by removing and replacing the dangerous, obfuscated malware 22), the server 26 may safely simulate execution of the script command 28 without the risk of executing/activating the obfuscated malware 22. The simulated result 52 of the script command 28 thus safely reveals the true intent of the obfuscated malware 22.

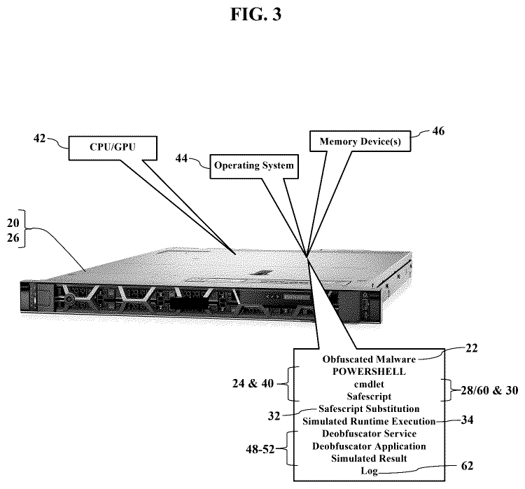

FIG. 3 illustrates more examples using Microsoft's POWERSHELL® scripting language 40. Microsoft's POWERSHELL® is a command-line shell and scripting language that is installed by default on many computer systems (such as MICROSOFT WINDOWS® machines). Microsoft's POWERSHELL® scripting language 40, though, is commonly used by cybercriminals as an attack tool. Many forensic studies have shown that cybercriminals obfuscate their malware 22 within the POWERSHELL® script commands 28. Detecting malicious PowerShell commands 28, within the high volume of benign PowerShell commands 28, is conventionally very challenging and time consuming. Any delay in detecting the malware 22 may be too late to stop harmful activities.

The computer system 20 (again illustrated as the server 26), however, automatically detects and reveals the malware 22 within the POWERSHELL® script commands 28. As typical of scripting languages 40, the POWERSHELL® script commands 28 may be either executed directly via the command line or as part of a textual script. PowerShell's functionality is greatly extended using thousands of the commands 28 (e.g., command-lets or cmdlets 60). Each cmdlet 60, for example, may be a modular and reusable textual script, and each cmdlet 60 may have its own designated functionality. While many cmdlets 60 are built into the POWERSHELL® scripting language 40 (such as Get-Process and Invoke-Command), many more cmdlets 60 may be loaded from external modules to further enrich programming capabilities. Because there are thousands of the cmdlets 60, cybercriminals have found many ways of obfuscating their malware 22 within POWERSHELL® script commands 28.

Again, though the deobfuscator application 50 deobfuscates the malware 22. The deobfuscator application 50 instructs the computer system 20 (again illustrated as the server 26) to identify the content representing the cmdlet 60 within the textual code/language 24/40. The deobfuscator application 50 instructs the server 26 to identify the safescript 30 that corresponds to the cmdlet 60. The deobfuscator application 50 then causes the server 26 to deobfuscate the malware 22 by performing the simulated runtime execution 34 of the textual script/code 24 using the safescript 30 instead of the cmdlet 60. That is, the server 26 performs the safescript substitution 32 by substituting the cmdlet 60 for its corresponding safescript 30. Once the textual script/code 24 has been safely modified using the safescript substitution 32, the deobfuscator application 50 instructs or causes the server 26 to perform the simulated runtime execution 34 of the textual script/code 24 using the safescript 30. The deobfuscator application 50 may also perform logging operations (e.g. log 62) that record/log the cmdlet 60, the safescript substitution 32, and the simulated runtime execution 34.

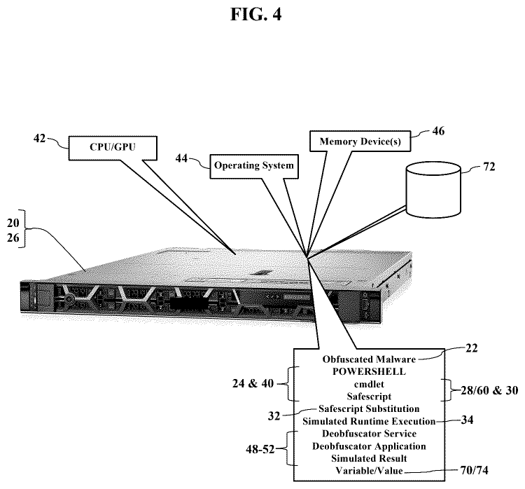

FIG. 4 illustrates examples of the simulated runtime execution 34. Because Microsoft's POWERSHELL® is pre-installed on WINDOWS® machines, these examples mimic a typical MICROSOFT WINDOWS® system. The computer system 20 (again illustrated as the server 26) identifies variables 70 (such as $PSHome) that may be referenced in the textual script/code 24 and/or by the obfuscated malware 22. The deobfuscator application 50, for example, may identify the variable 70 by comparing the textual script/code 24 to an electronic variable database 72 of the variables 70 and their corresponding values 74. FIG. 4 illustrates the variable database 72 as being locally stored in the memory device 46 of the server 26. The variable database 72, for example, may be embedded within the deobfuscator application 50. The variable database 72, though, may be remotely located and accessed as a network resource. The deobfuscator application 50, as more examples, may query the electronic variable database 72 by specifying the textual variable 70 as a query parameter. The variable database 72 performs a database lookup and retrieves the value 74 that corresponds to the variable 70. The variable database 72 then provides/sends a query response that specifies the value 74 that corresponds to the variable 70. When the deobfuscator application 50 receives the query response, the deobfuscator application 50 cooperates with the operating system 44 to substitute the value 74 for the variable 70 (such as the $PSHome). The deobfuscator application 50 has thus replaced the variable 70 with its safer value 74 that may be referenced in the obfuscated malware 22. The deobfuscator application 50 may thus substitute expected value(s) 74 of the variable 70 for proper operation. Again, then, the server 26 may deobfuscate the malware 22 by performing the simulated runtime execution 34 using the value 74 of the well-known variable 70 referenced in obfuscated malware 22.

The variable database 72 of the variables 70 may be a rich repository. The variable database 72, for example, may have many database entries that map many variables 70 and their corresponding values 74 (such as, for example, those referenced by https://ss64.com/nt/syntax-variables.html). For example, for the “ProgramData” variable 70, an attacker can expect it to be equal to “C:\ProgramData” on a vast majority of victim machines. It could be “E:\ProgramData” or something totally different, but on most machines, it will be “C:\ProgramData”. Now, suppose the attacker needs to invoke a command called “dump”, which supposedly does something bad, such as print out contents of some protected memory that attacker intends to steal. The attacker does not want to include the word “dump” literally into the script because that would be very easy for a pattern matching detection to pick up. Instead, the attacker does something like this: “Execute $ProgramData[10]+“u”+$ProgramData[9]+$ProgramData[3].” This would not trigger any kind of pattern-based detector. And yet, on the vast majority of victim machines, “$ProgramData[10]” will evaluate to the 10th character of string “C:\ProgramData” which is a D (indexing is 0-based). Similarly for the others. In effect, this becomes equivalent to Execute “DumP”. Commands are case-insensitive, so it will actually execute the dump command that the attacker was after.

More examples are provided. The variable database 72, for example, supplies realistic values 74 to the variables 70 in the safescript 30, thus allowing the safescript 30 to perform the operations as the malware 22 intended, but in a simulated and safe context (such as the simulated runtime execution 34). Malware code will then be allowed to execute in a simulated environment just enough to go from “$ProgramData[10]+“u”+$ProgramData[9]+$ProgramData[3]” to “DumP”, at which point the intention of the malware 22 becomes clear and can be logged, intercepted, or otherwise responded to.

The variable database 72 may thus map the variable 70 to several sets of values 74 to simulate different types of environments (such as different WINDOWS® versions). The deobfuscator service 48, as examples, may implement/embed/query multiple variable databases 72, and each different variable database 72 may correspond to a different operating system versions, different computing environments, different types of malware 22, or whatever other information is targeted for deobfuscation. Each different variable database 72, for example, may represent a self-consistent set of values 74 as might be found on a particular type of an environment. It could be, for example, that the malware 22 is designed to target Windows98 machines only. Then running the safescript deobfuscator with the Windows98 variable database 72 would provide that environment for malware 22 to activate and run as intended (albeit in a simulated safe context). Similarly, other variable databases 72 may be defined or configured to match various realistic environments that malware 22 might expect to find.

Even more examples are provided. Some malware 22 has features that are intended to detect that they are running in a simulated context. One of the primary means of doing so is checking for values 74 of obscure variables 70 to see if they are unusual in some way. This would let malware 22 know that it isn't running on a typical victim machine and it can break off the attack activities to avoid being detected. Safescript 30, though, uses the multiple versions of the variable databases 72 per target environment. This allows the safescript 30 to randomly choose from among a number of realistic-looking environments, thus making to it harder for malware 22 to detect that it is running under safescript observation. The deobfuscator application 50, for example, may identify the target environment (such as the versional operating system and/or computing environment) and select which one or more of the variable databases 72 is defined for the target environment. The deobfuscator application 50, as more examples, may randomly select one or more of the variable databases 72 to use. The deobfuscator application 50, as more examples, may randomly select one of the variable databases 72 according to the AST 80, the node 82, and/or the nodal content 84. The deobfuscator application 50 may thus implement a different variable database 72 when reading different ASTs 80, different nodes 82, and/or different nodal contents 84.

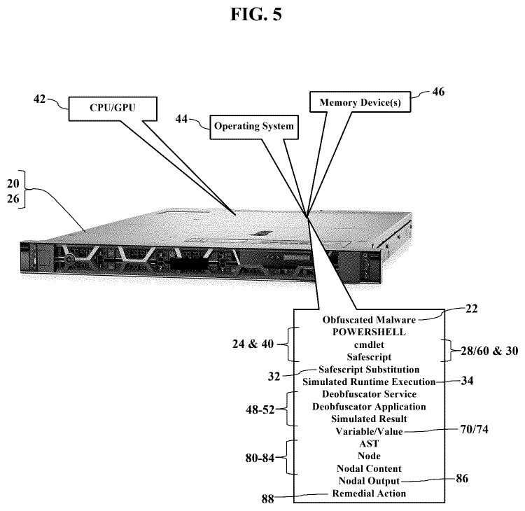

FIG. 5 illustrates examples of abstract simulated execution. The computer system 20 (again illustrated as the server 26) accepts input snippets or samples of the code 24 (such as source code, POWERSHELL®, or JAVASCRIPT®, perhaps benign or containing the obfuscated malware 22) and parses the input code 24 to generate an abstract syntax tree 80 (or AST). The AST 80 is a data structure used in computer science to represent the structure of the input code 24. The AST 80 may be a graphical tree representation having many nodes 82, with each node 82 denoting a construct occurring in the textual input code 24. Each node 82 may thus be associated with nodal content 84 describing its programming construct. The deobfuscator application 50 inspects the nodal content 84 and identifies the textual content representing the cmdlet 60. If the nodal content 84 contains or specifies the cmdlet 60, then the deobfuscator application 50 identifies the safescript 30 that corresponds to the cmdlet 60. The deobfuscator application 50 may perform the safescript substitution 32 that swaps the cmdlet 60 from within the nodal content 84 with the corresponding safescript 30. The deobfuscator application 50 may additionally or alternatively identify the variable 70 in the nodal content 84 and replace the variable 70 with its corresponding value 74. The deobfuscator application 50 may then generate a nodal output 86 that deobfuscates the malware 22 by performing the simulated runtime execution 34 of the nodal content 84 having the safescript 30 and/or the value 74 substituted therein. The deobfuscator application 50 may then replace the nodal content 84 associated with the node 82 of the AST 80 with the nodal output 86 that deobfuscated the malware 22. The deobfuscator application 50 may perform the safe optimization for other nodes 82 associated with AST 80, thus deobfuscating the malware 22 at the other nodes 82. Once the malware 22 is revealed and detected, the deobfuscator application 50 may arrange, oversee, request, handoff, or otherwise order up cybersecurity remedial actions 88. The deobfuscator application 50 may implement the remedial actions 88 to stop/halt/isolate/quarantine the malware 22.

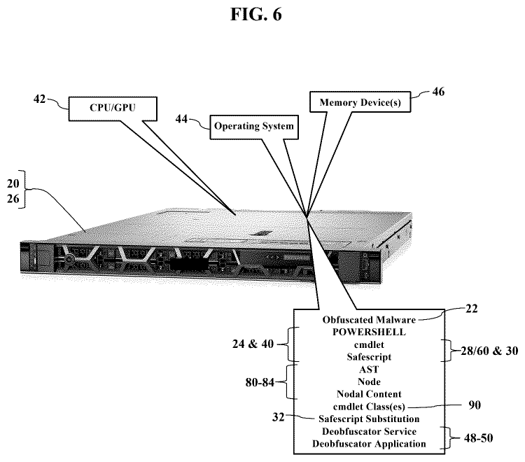

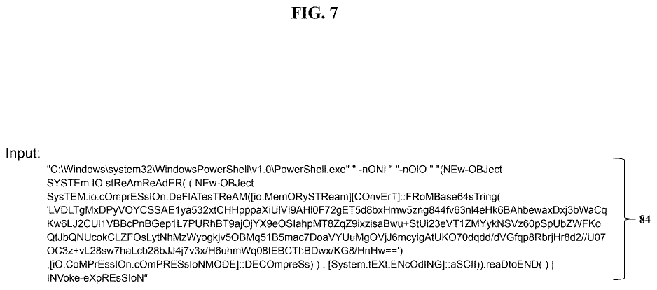

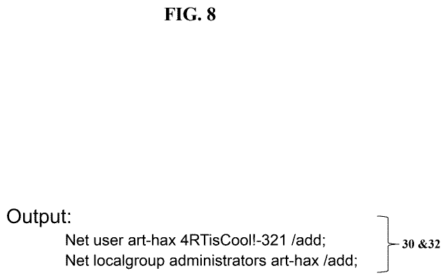

FIGS. 6-8 illustrate more examples of malware deobfuscation. The computer system 20 (again illustrated as the server 26) modifies/optimizes the nodal content 84 associated with the AST 80 to deliver faster cybersecurity malware detections in the scripting languages 40. The deobfuscator application 50, for example, optimizes the scripting command 28 (such as the cmdlet 60). As FIG. 6 illustrates, the deobfuscator application 50 may implement different varieties of the safescript 30 using different classes 90 of the scripting commands 28. FIG. 7, for example, illustrates an example of the input nodal content 84, while FIG. 8 illustrates an example of the resulting output optimization (e.g., the safescript substitution 32 and the safescript 30). The POWERSHELL® scripting language 40 allows a user/administrator to use syntax to define different classes 90 of the POWERSHELL® cmdlets 60. The classes 90 may be defined according to properties, methods, inheritances, resources, attributes, the variables 70, parameters, name, and other configurations. Whatever the classes 90, though, the deobfuscator service 48 may define or implement the safescript 30 that corresponds to each cmdlet 60 and/or to each POWERSHELL® class 90. So, once the cmdlet 60 is read and identified (such as in the nodal content 84 associated with the node 82 of the AST 80), the deobfuscator application 50 may retrieve the safescript 30 that corresponds to the POWERSHELL® cmdlet 60 and/or to the class 90. Each POWERSHELL® class 90 may recognize and implement the multitude of options and behaviors that the corresponding POWERSHELL® cmdlet 60 tends to exhibit. Each POWERSHELL® class 90 may ensure that pattern matching on the AST 80 only occurs once per cmdlet 60. When the cmdlet 60 is recognized, its corresponding safescript 30 is instantiated and inserted instead of the generic AST nodal content 84. Once so inserted, matching no longer needs to be done on this node 82.

Microsoft's POWERSHELL® provides more examples. The deobfuscator application 50 inspects the nodal content 84 and identifies a POWERSHELL® command (such as the cmdlet 60). Once the POWERSHELL® command is recognized, the POWERSHELL® command is instantiated and inserted instead of the generic AST nodal content 84. That is, the command class is instantiated and inserted in the object oriented programming sense. The command class is a module or other component of the deobfuscator application 50 that represents this specific command. The command class, for example, may contain the safe implementation of the POWERSHELL® command (such as the safescript 30).

The deobfuscator application 50 may thus apply the safescript 30 to simulate execution of the cmdlet 60. There may be several cases. For example, if the input code 24 and/or the nodal content 84 contains, or is, a constant value(s), the safescript 30 may compute its result. In this case, the cmdlet 60 and an attached nodal subtree may be removed and replaced with the constant value representing the simulated result. If one of the inputs is itself the cmdlet 60, then the safescript 30 may be recursively applied before proceeding. If one of the inputs is a generic AST non-constant node 82, then the deobfuscator application 50 may deny simulated evaluation. The simulated evaluation is not possible but may be attempted if the subtree is modified by subsequent steps.

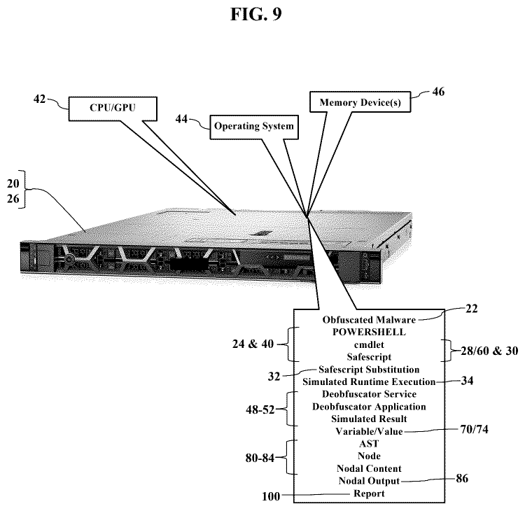

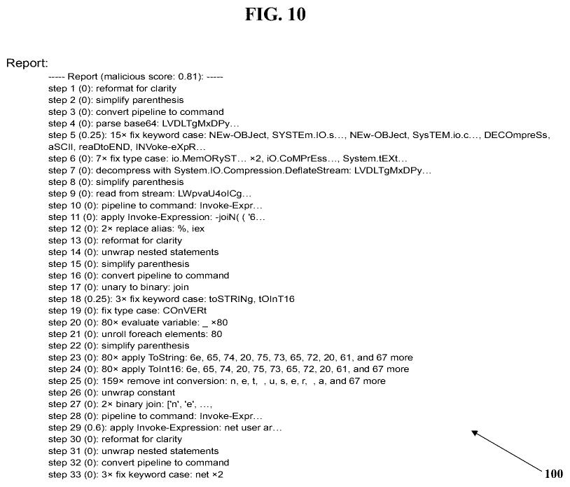

Still more examples are provided. The deobfuscator application 50 inspects the nodal content 84 and analyzes a fragment of a script that reads “DeleteFile $some+complicated(“expression”+here).” The command here is “DeleteFile”, which normally deletes a file from the file system of the computer system 22. This command is destructive and could cause damage if executed. But the command could also be benign, if the file being deleted is located in a C:\Temp directory (as an example). Note, however, that the file being deleted not identified, because “$some+complicated(“expression”+here)” still needs to be simplified and deobfuscated. The deobfuscator application 50 replaces the “DeleteFile” node with a new node with the safescript 30 implementation of the DeleteFile command (let's call it “_SAFE_DeleteFile_”), making this in effect into “_SAFE_DeleteFile_$some+complicated(“expression”+here)”. Both the “safe” and the “original” command versions know to evaluate the first argument as a string and interpret it as a name of the file to delete. But the safescript 30 version will not delete the file. Instead, the safescript 30 version will analyze the resulting name and check whether the effects are dangerous or benign. The safescript 30 version will then log/report the dangerous/benign (as explained with reference to FIGS. 9-10) and assign a corresponding malicious score to itself, to be aggregated by the deobfuscator application 50.

Even more examples are provided. A more complicated example might be a command that itself evaluates to something. Let's say there is a command called “LoadFile”, which normally reads a file from the file system and returns a string with the file contents. Suppose the deobfuscator application 50 is analyzing a fragment of a script that reads “SendMail “hacker@bad.com” (ReadFile $some+complicated(“expression”+here)). When working on the “ReadFile” portion of this AST, the deobfuscator application 50 will instantiate the safescript 30 version of this command (let's call it “_SAFE_ReadFile”). Just like the original version, the safescript 30 version will know to evaluate the first argument as a string and analyze as a file name (similar to the above “DeleteFile” example). The safescript 30 version, however, will not actually read any files (that would be unsafe), but the safescript 30 version does need to simulate the expected effects of the original command so that the deobfuscator application 50 can make sense of the surrounding expression. The safescript 30 and/or the deobfuscator application 50 may thus output a string that reads “contents of file XYZ” where XYZ is the result of evaluation of its first argument. This, of course, is not the actual content of the file, but it is enough to modify the original fragment into “SendMail “hacker@bad.com” “contents of file XYZ” and this lets the deobfuscator application 50 proceed with the rest of the AST analysis.

FIGS. 9-10 illustrate examples of deobfuscation reporting. The computer system 20 (again illustrated as the server 26) may may log/record each step of the deobfuscation process, thus generating a detailed obfuscation/deobfuscation report 100 that shows the transformations applied to the script (such as the nodal content 84). This obfuscation/deobfuscation report 100 preserves information about the obfuscation techniques used, enabling the identification of threat actor TTPs (e.g., Tools, Techniques, and Procedures). The deobfuscation service 48 may thus additionally use clustering techniques to group similar scripts based on their obfuscation patterns, aiding in threat intelligence and actor identification.

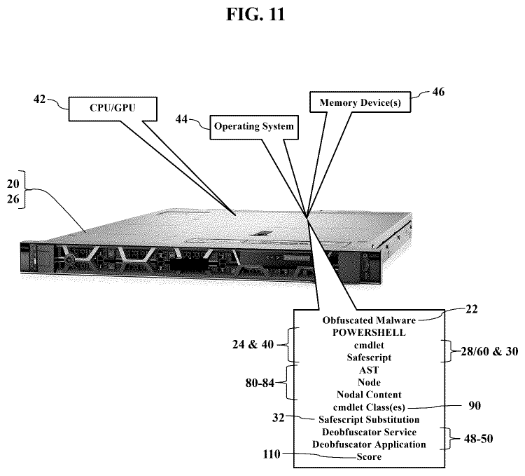

FIG. 11 illustrates examples of maliciousness scoring. Here the deobfuscator application 50 may generate and assign a maliciousness score 110 to each detected threat actor TTP. The deobfuscator application 50 may additionally or alternatively generate an overall maliciousness score by combining individual maliciousness scores 110 of the observed TTP and normalizing to a range from 0 to 1. The overall maliciousness score may thus be used by as a signal into detection tools to indicate probability of whether the script is malicious.

Computer functioning is greatly improved. The deobfuscated malware 22 is revealed, thus allowing the cybersecurity remedial actions 88 to be implemented. Simply put, computer hardware/software resources are saved from harmful/malicious code. Moreover, the deobfuscation techniques are much faster than conventional schemes. Conventional deobfuscation process schemes are slow at generally O(m*n\hat{ }), where m is the number of recognized optimizations (such as the safescript substitutions 32 and/or the variable substitutions explained with reference to FIG. 4) and n is the number of nodes 82 in the AST 80. The deobfuscator application 50, though, by performing the safescript substitution 32, reduces runtime complexity to O(m*n). The deobfuscator application 50 may thus deobfuscate the malware 22 using less computer resources and less time. The server 26 thus detects the malware 22 much faster for quicker and safer cybersecurity remedial actions 88.

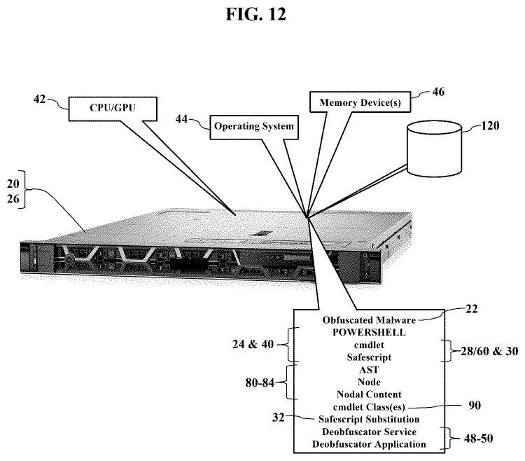

FIGS. 12-14 illustrate more examples of the safescript substitution 32. The computer system 20 (again illustrated as the server 26) deobfuscates the malware 22 using the safescript substitution 32. The deobfuscator application 50 instructs the server 26 to identify the content representing the cmdlet 60 within the nodal content 84. The deobfuscator application 50 instructs the server 26 to identify the safescript 30 that corresponds to the cmdlet 60. The deobfuscator application 50 then causes the server 26 to deobfuscate the malware 22 by performing the simulated runtime execution 34 of the textual nodal content 84 having the safescript 30 substituted therein for the cmdlet 60. That is, the server 26 performs the safescript substitution 32 by substituting the cmdlet 60 for its corresponding safescript 30.

FIG. 12 also illustrates database lookups. The server 26 may itself generate the AST 80 and/or the nodal content 84 associated with the tree node 82. The server 26, however, may rely on other network resources to generate the AST 80, so the server 26 may receive the nodal content 84 as an outsourced service result. Whatever the service architecture, the server 26 inspects the nodal content 84 for the textual presence of the command(s) 28 (such as the POWERSHELL® cmdlet(s) 60). When the server 26 identifies the textual string characters representing the command/cmdlet 28/60, the deobfuscator application 50 instructs the server 26 to identify the safescript 30 that corresponds to the command/cmdlet 28/60. The deobfuscator application 50, for example, may cause the server 26 to query a command/cmdlet database 120. The command/cmdlet database 120 stores electronic records of each command/cmdlet 28/60 and its/their corresponding safe implementation (e.g., the safescript 30). While the command/cmdlet database 120 may be remotely stored and accessed/queried from a networked location, FIG. 12 illustrates local resourcing. That is, the command/cmdlet database 120 is locally stored in the memory device 46 of the server 26.

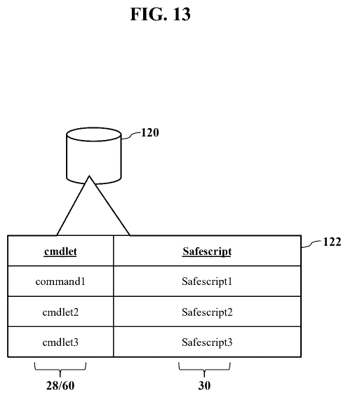

FIG. 13 illustrates more examples of the command/cmdlet database 120. As this disclosure above explained, there are many scripting languages 40, and each scripting language 40 may have thousands of different commands 28 (such as the POWERSHELL® cmdlets 60). Moreover, because the deobfuscator service 48 may be agnostic to the scripting language 40, the command/cmdlet database 120 may have many thousands of database entries maintaining a rich repository of different commands/cmdlets 28/60 and its/their corresponding safescripts 30. Such a large command/cmdlet database 120 is too difficult to illustrate, so FIG. 13 merely illustrates a simple example having only a few database entries. That is, even though the command/cmdlet database 120 may have other logical structures, a relational database is perhaps easiest to understand. FIG. 13 thus illustrates the command/cmdlet database 120 as a table 122 having row and columnar database entries that map, relate, convert, or associate different commands/cmdlets 28/60 to their corresponding safescript(s) 30. When the server 26 receives each command/cmdlet 28/60 and/or the safescript 30, the deobfuscator application 50 may add database entries that log each command/cmdlet 28/60 to its corresponding safescript 30. The server 26 may also log a corresponding date/time stamp and/or other service data (not shown for simplicity).

The server 26 may query the command/cmdlet database 120. When the server 26 identifies the command/cmdlet 28/60 in the nodal content 84 (illustrated in FIG. 12), the deobfuscator application 50 instructs the server 26 (both illustrated in FIG. 12) to identify the safescript 30 by querying the command/cmdlet database 120. The deobfuscator application 50, for example, generates a database query that specifies the command/cmdlet 28/60 as a query parameter. The deobfuscator application 50 instructs the server 26 to send the database query to the local/remote command/cmdlet database 120. The command/cmdlet database 120 (performing as a query handler) searches the database entries for the command/cmdlet 28/60 and looks up the corresponding safescript 30. The command/cmdlet database 120 generates a query response that specifies the safescript 30, and the command/cmdlet database 120 (and/or the network resource) sends the query response.

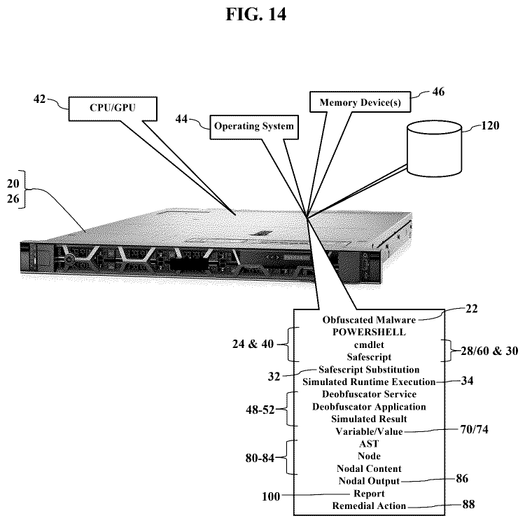

As FIG. 14 illustrates, the optimization is executed. When the deobfuscator application 50 receives the query response, the deobfuscator application 50 may then execute the safescript substitution 32. The deobfuscator application 50, for example, cuts the command/cmdlet 28/60 from within the nodal content 84 and pastes/inserts the safescript 30. The deobfuscator application 50 thus modifies the textual nodal content 84 by removing the characters that correspond to the command/cmdlet 28/60 and by replacing with the safescript 30. Once the nodal content 84 is optimized (perhaps by also replacing the variable(s) 70 with its/their corresponding value(s) 74, as explained with reference to FIG. 4), the deobfuscator application 50 may then generate the nodal output 86. The deobfuscator application 50 causes the server 26 to deobfuscate the malware 22 by performing the simulated runtime execution 34 of the nodal content 84 having the safescript 30 and/or the value 74 substituted therein. The deobfuscator application 50 may then replace the nodal content 84 associated with the node 82 of the AST 80 with the nodal output 86 that deobfuscated the malware 22. The deobfuscator application 50 may repeatedly perform the safe optimization for other nodes 82 associated with AST 80, thus deobfuscating other malware 22 at the other nodes 82. Each optimizing may be logged and the report 100 generated. Once the malware 22 is/are revealed and detected, the cybersecurity remedial actions 88 may be implemented to stop/halt/isolate/quarantine the malware 22.

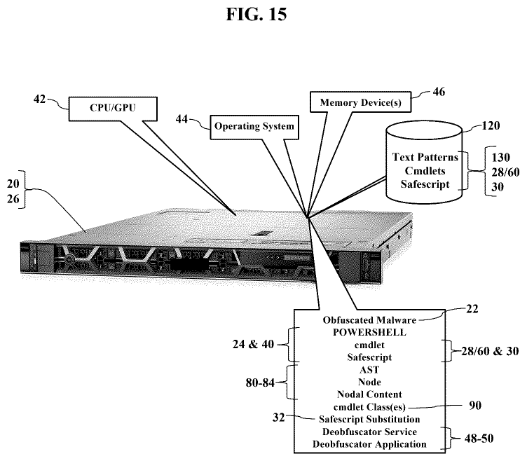

FIG. 15 illustrates examples of textual pattern matching. Here the deobfuscation service 48 may use textual pattern matching for the safescript substitution 32. The command/cmdlet database 120, for example, may have database entries that map, relate, convert, or associate different text patterns 130 to their corresponding safescript(s) 30. The deobfuscator application 50 may thus instruct the computer system 20 (again illustrated as the server 26) to merely read one or more strings of characters (i.e., alphanumeric text) in the nodal content 84 and query the command/cmdlet database 120. Simply put, if the textual nodal content 84 matches one of the text patterns 130, then the deobfuscator application 50 identifies and retrieves the corresponding safescript 30. Again, because the deobfuscator service 48 may be agnostic to the scripting languages 40, the command/cmdlet database 120 may store thousands/millions of text patterns 130 and their corresponding safescripts 30. The deobfuscator service 48 may thus grow its malware capabilities by storing a wide diversity of text patterns 130 and their desired safescript 30 implementations.

Computer functioning is further improved. The deobfuscator application 50 detects the malware 22 using automatic deobfuscation, improved deobfuscation techniques, a simulated environment, and a simulated execution. The deobfuscator application 50 dynamically resolves the input code (such as the nodal content 84) that would otherwise require execution, without the risk of running malicious commands 28 in a real environment and without the need to create sandbox environments. The deobfuscator application 50 thus functions as both an interpreter and an optimizer.

Still more computer functioning is improved. Some forms of obfuscation rely on dynamic code execution, such as creating objects, modifying properties, and invoking methods that decrypt or decompress malicious code. The simulated execution of obfuscated scripts, even those that rely on complex runtime behaviors, ultimately reveals the true intent of the script without risk of letting it activate. The deobfuscation service 48 may also log each step of the deobfuscation process, generating the detailed deobfuscation report 100 that shows the transformations applied to the script. This deobfuscation report 100 preserves information about the obfuscation and actor identification.

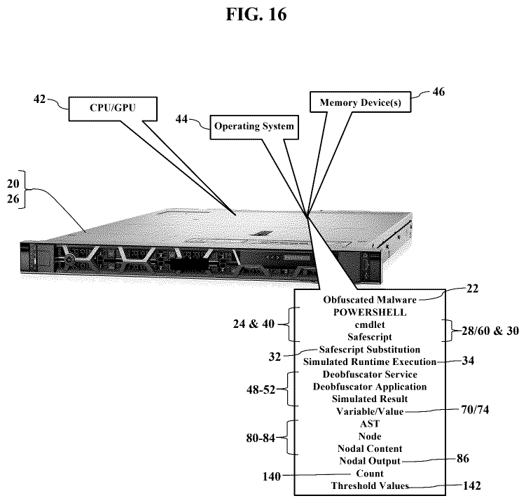

FIG. 16 illustrates more examples of improved computer functioning. The deobfuscator service 48 greatly reduces the runtime complexity to O(m*n), where m is the number of recognized optimizations (such as the safescript substitutions 32 and/or the variable substitutions explained with reference to FIG. 4) and n is the number of nodes 82 in the AST 80. The number of the safescript substitutions 32, in other words, may represent a severity, risk, and/or priority of the deobfuscated malware 22. For example, if the deobfuscation technique is complex or time consuming, multiple safescript substitutions 32 may indicate greater risk and urgency. The deobfuscator application 50, then, may maintain a safescript substitution count 140 for each node 82 of the AST 80. As the deobfuscator application 50 optimizes the nodal content 84 for each node 82, the deobfuscator application 50 may initialize the safescript substitution count 140 (e.g., a zero initial value) that counts or increments with each safescript substitution 32 performed on the nodal content 84. That is, each time the command/cmdlet 28/60 is identified and replaced with its corresponding safescript 30, the deobfuscator application 50 may increment the safescript substitution count 140. The safescript substitution count 140 has a final value when the deobfuscator application 50 completes the safescript substitutions 32 performed on the nodal content 84. The deobfuscator application 50 may then compare a current value and/or the final value of the safescript substitution count 140 to one or more threshold values 142. Each threshold value 142 may represent a corresponding severity or risk of the obfuscated malware 22 detected and resolved/optimized within the nodal content 84. So, as more and more safescript substitutions 32 are required, the greater the severity or risk of the obfuscated malware 22. If, for example, only a single (1) safescript substitution 32 is required to optimize the nodal content 84, then perhaps the malware 22 may have a low risk (perhaps implying an unsophisticated obfuscation scheme). If, however, ten (10) safescript substitutions 32 are required to optimize the nodal content 84, then the malware 22 may have a high risk. The malware 22, in other words, may represent a sophisticated and/or novel obfuscation scheme that should be urgently analyzed/evaluated for the appropriate remedial cybersecurity action 88. The deobfuscation service 48 may thus have different threshold values 142, with each threshold value representing the corresponding risk/severity of the malware 22.

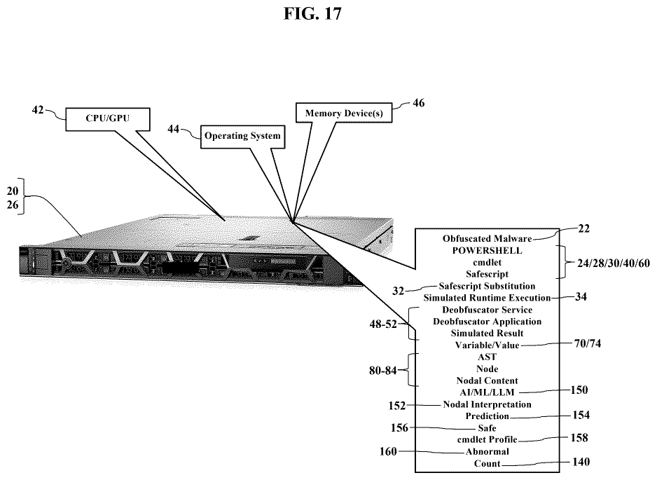

FIG. 17 illustrates examples of natural language assessment. Because the nodal content 84 is textual characters, natural language processing (or NLP) may be used to interpret and simplify the nodal content 84. The computer system 20 (again illustrated as the server 26), as examples, may read the nodal content 84 associated with the node 82 of the AST 80. The deobfuscator application 50, as further examples, may or may not have applied the safescript substitution(s) 30 to optimize the nodal content 84. The deobfuscator application 50 may then send or apply some or all of the nodal content 84 (e.g., pre-optimized or post-optimized) as an input to an AI, ML, large language model 150 (i.e., AI/ML/LLM). The AI/ML/LLM 150 then generates a nodal interpretation 152 as perhaps a natural language output, based on the inputted nodal content 84. The AI/ML/LLM 150, as an example, may be sub-service or component of the deobfuscation service 48. The AI/ML/LLM 150, however, may be outsourced to a subcontractor or other service provider (such as Meta's CODE LLAMA® or Open AI's CHATGPT®). The model representing the AI/ML/LLM 150 may be trained to interpret the nodal content 84. As an example, the AI/ML/LLM 150 may be the pre-trained using deep, neural networking and massive amounts of training data to predict patterns in textual sequences (such as the nodal content 84). The AI/ML/LLM 150, in particular, may be pre-trained using documentation describing different commands 28 (such as the cmdlets 60). The AI/ML/LLM 150 is thus trained to generate the nodal interpretation 152 associated with the nodal content 84. Indeed, the AI/ML/LLM 150 may further be trained to generate a cybersecurity nodal prediction 154 based on the nodal interpretation 152.

The AI/ML/LLM 150 may thus be trained as a predictor engine. The AI/ML/LLM 150 may be trained using the different commands 28 (such as the cmdlets 60) and their corresponding safescripts 30. The deobfuscation service 48 (such as a cloud computing environment) may train the AI/ML/LLM 150 using historically-observed commands/cmdlets 28/60 and their corresponding safescripts 30. Indeed, the deobfuscation service 48 may log days/weeks/months/years of nodal content 84 that is/are associated with safe or normal operation 156. As a simple example, the AI/ML/LLM 150 may generate a cmdlet profile 158 using Gaussian probability distributions based on training data derived from different nodal content 84 and their corresponding safescripts 30. One or more standard deviations and confidence intervals may then be calculated to predict the nodal content 84 that represent the safe or normal operation 156. As the deobfuscator application 48 inspects current nodal content 84, statistical models may be used to predict that the current nodal content 84 conforms to, matches, or deviates from the cmdlet profile 158.

The server 26 may generate the cybersecurity nodal prediction 154. When the current nodal content 84 conforms to the cmdlet profile 158, the deobfuscator application 48 may thus instruct the server 26 to determine the current nodal content 84 is the safe or normal operation 156. The server 24 may thus generate the cybersecurity nodal prediction 154 as an output, and the cybersecurity nodal prediction 154 determines, or predicts, that the current nodal content 84 is the safe or normal operation 156. In simple words, because the current nodal content 84 sufficiently matches some historical nodal content previously logged or observed, the deobfuscator application 48 may instruct the server 26 to label, sort, or classify the current nodal content 84 as the safe or normal operation 156. The current nodal content 84 may further be labeled, sorted, or classified as benign, low priority, and/or not requiring further investigation.

The server 26, however, may predict an unsafe or abnormal operation 160. When the current nodal content 84 fails to conform to the cmdlet profile 158, then the deobfuscator application 48 may determine that the current nodal content 84 is the unsafe or abnormal operation 160. The current nodal content 84, for example, may represent an unknown textual sequence not historically logged or observed. The current nodal content 84, as another example, may represent processes, cmdlets, API calls, and/or timings that statistically lie outside the cmdlet profile 158. A mismatch or deviation from the cmdlet profile 158 may determine the unsafe or abnormal operation 160. Because the current nodal content 84 fails to conform to the cmdlet profile 158, the deobfuscator application 48 may further label or categorize the current nodal content 84 as the unsafe or abnormal operation 160. The deobfuscator application 48 may further generate and send nodal alert notifications to notification/destination network/IP addresses that alert machines/systems/personnel to the unsafe or abnormal operation 160. As more examples, the deobfuscator application 48 may deny and/or the terminate the nodal content 84.

The cmdlet profile 158, as more examples, may reflect or represent the safescript substitution count 140. As the deobfuscation service 48 logs service records, the deobfuscation service 48 may also record/log the safescript substitution count 140 performed for each historically-observed command/cmdlet 28/60 and its corresponding safescript(s) 30. The cmdlet profile 158 may thus be additionally or alternatively trained using historically-observed commands/cmdlets 28/60, their corresponding safescripts 30 and their corresponding safescript substitution counts 140. The cmdlet profile 158 may then statistically describe (perhaps again using Gaussian probability distributions) different nodal content 84 and their corresponding safescript substitution counts 140. One or more standard deviations and confidence intervals may then be calculated to predict the nodal content 84 that represent the safe or normal operation 156. As the deobfuscator application 48 inspects current nodal content 84, statistical models may be used to predict that the current nodal content 84 conforms to, matches, or deviates from the cmdlet profile 158. When the current nodal content 84 (and the nodal safescript substitution count 140) conforms to the cmdlet profile 158, the server 24 may generate the cybersecurity nodal prediction 154 that the current nodal content 84 is the safe or normal operation 156. When, however, the current nodal content 84 (and the nodal safescript substitution count 140) fails to conform to the cmdlet profile 158, the server 24 may predict that the current nodal content 84 is the unsafe or abnormal operation 160.

The deobfuscation service 48 may perform data transformations and feature engineering. The server 26, for example, may perform a cmdlet tokenization operation. The cmdlet tokenization operation uses the nodal content 84 (such as the raw and/or optimized cmdlets 60) and generates one or more cmdlet tokens. The server 26 may thus tokenize the cmdlets 60, and the cmdlet tokens represent words, character sets, or combinations of words and punctuation contained within the nodal content 84. The AI/ML/LLM 150 may tokenize the nodal content 84 as textual training data and analyze patterns and semantic relationships between the cmdlet tokens. After training, for example, the nodal content 84 may use those patterns and relationships to generate a sequence of output tokens based on the inputted cmdlet tokens. The server 26 may use a tokenization scheme or method, such as word tokenization, character tokenization, and subword tokenization, byte-pair encoding, and others as desired. The AI/ML/LLM 150 may assign a unique cmdlet token identifier to each cmdlet token. The AI/ML/LLM 150 may thus represent the cmdlet 60 and/or the nodal content 84 as a sequence of cmdlet token identifiers. The AI/ML/LLM 150 may then generate cmdlet token embeddings (using the cmdlet token identifiers) that represent semantic relationships between the cmdlet tokens. Each cmdlet token embedding is assigned to a corresponding one of the cmdlet tokens, based on how commonly the corresponding cmdlet token is used together with, or in similar contexts to, the other cmdlet tokens. After the AI/ML/LLM 150 is trained, the AI/ML/LLM 150 may use the learned cmdlet token embeddings to iteratively generate an output.

The deobfuscation service 48 may be remotely called. The deobfuscation service 48 may be a cloud service offered by a cloud computing environment. The computer system 20 (such as the server 26) may thus be a networked member of the cloud computing environment that provides at least a portion of the deobfuscation service 48. Computer clients/customers may thus request the deobfuscation service 48 by sending service requests to a network/IP address associated with the cloud computing environment and/or the deobfuscation service 48. The computer clients, for example, may download, store, and execute an endpoint cybersecurity agent. The endpoint cybersecurity agent cooperates with the host operating system to monitor for uses of the scripting language 40. The endpoint cybersecurity agent, for example, may register for and receive OS event notifications associated with Microsoft's POWERSHELL® scripting language 40. When the event notification describes or references the command/cmdlet 28/60 and/or the nodal content 84, for example, the endpoint cybersecurity agent cooperates with the host operating system to send/upload the command/cmdlet/content 28/60/84 to the deobfuscation service 48. The cloud computing environment may then route/forward the command/cmdlet/content 28/60/84 to the server 26. The server 26 analyzes and optimizes the command/cmdlet/content 28/60/84 (as this disclosure explains). The server 26 may then send a service response. If, for example, the command/cmdlet/content 28/60/84 represents the safe/normal operation 156, then the deobfuscation service 48 may approve the command/cmdlet/content 28/60/84 and authorize the endpoint cybersecurity agent to execute the command/cmdlet/content 28/60/84. If, however, the command/cmdlet/content 28/60/84 represents the abnormal operation 160, then the deobfuscation service 48 may disapprove/deny the command/cmdlet/content 28/60/84 and instruct the endpoint cybersecurity agent to block the command/cmdlet/content 28/60/84.

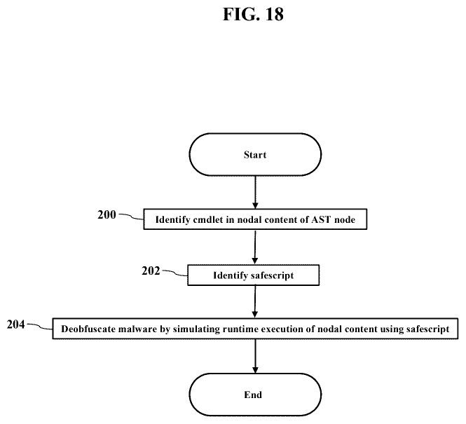

FIG. 18 illustrates examples of methods or operations that deobfuscate the malware 22. The cmdlet 60 is identified in the nodal content 84 associated with the node 82 of the abstract syntax tree 80 (or AST) (Block 200). The safescript 30 is identified (Block 202). The malware 22 is deobfuscated by simulating the runtime execution of the nodal content 84 using the safescript 30 (Block 204).

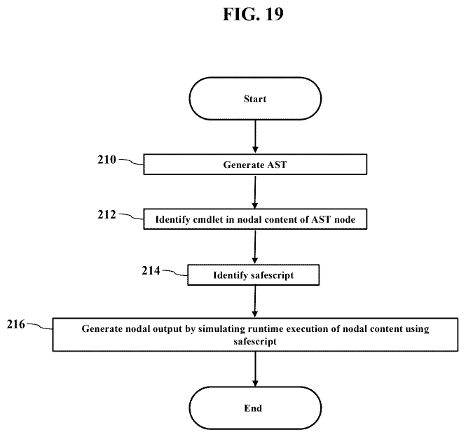

FIG. 19 illustrates more examples of methods or operations that deobfuscate the malware 22. The abstract syntax tree 80 (or AST) is generated (Block 210). The cmdlet 60 is identified in the nodal content 84 associated with the node 82 of the AST 80 (Block 212). The safescript 30 is identified (Block 214). The nodal output 86 is generated that deobfuscates the malware 22 by simulating the runtime execution using the safescript 30 instead of the cmdlet 60 (Block 216).

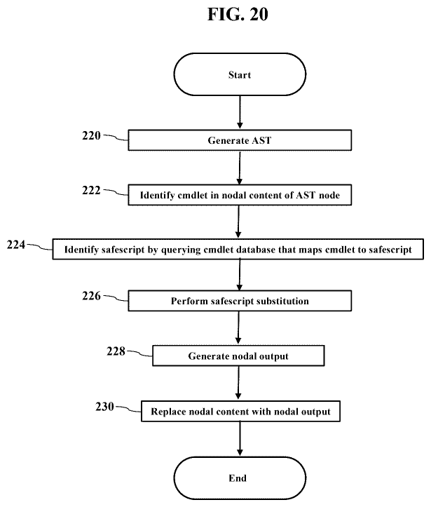

FIG. 20 illustrates more examples of methods or operations that deobfuscate the malware 22. The abstract syntax tree 80 (or AST) is generated (Block 220). The cmdlet 60 is identified in the nodal content 84 associated with the node 82 of the AST 80 (Block 222). The safescript 30 is identified by querying the electronic cmdlet database 120 that maps the cmdlet 60 to the safescript 30 (Block 224). The safescript substitution 32 is performed (Block 226) and the nodal output 86 is generated (Block 228). The nodal content 84 is replaced with the nodal output 86 (Block 230).

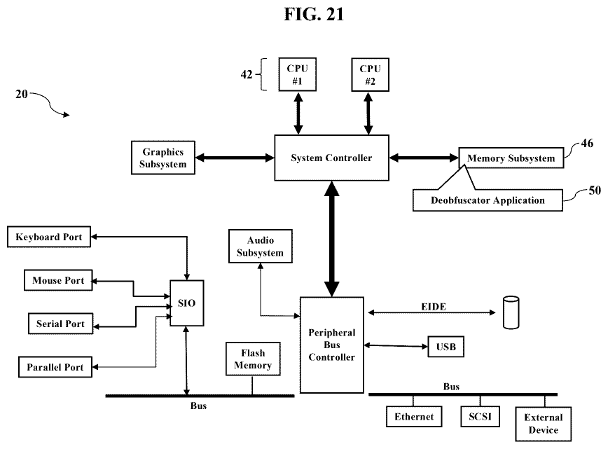

FIG. 21 illustrates a more detailed example of the operating environment. FIG. 21 is a more detailed block diagram illustrating the computer system 20. The deobfuscator application 50 is stored in the memory subsystem or device 46. One or more of the hardware processors 42 communicate with the memory subsystem or device 46 and execute the deobfuscator application 50. Examples of the memory subsystem or device 46 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 20 may have any embodiment. This disclosure mostly discusses the computer system 20 as the server 26. The deobfuscator service 48, however, may be easily adapted to mobile computing, wherein the computer system 20 may be a smartphone, laptop or desktop computer, a switch/router, a tablet computer, or a smartwatch. The deobfuscator service 48 may also be easily adapted to other embodiments of smart devices, such as a television, an audio device, a remote control, and a recorder. The deobfuscator service 48 may also be easily adapted to still more smart appliances, such as washers, dryers, and refrigerators. Indeed, as cars, trucks, and other vehicles grow in electronic usage and in processing power, the deobfuscator service 48 may be easily incorporated into any vehicular controller.

The above examples of the deobfuscator service 48 may be applied regardless of communications networking technology and networking environment. The deobfuscator service 48 may be easily adapted to stationary or mobile devices having wide-area networking (e.g., 4G/LTE/5G/6G cellular), wireless local area networking (WI-FI®), near field, and/or BLUETOOTH® capability. The deobfuscator service 48 may be applied to stationary or mobile devices utilizing any portion of the electromagnetic spectrum and any signaling standard (such as the IEEE 802 family of standards, GSM/CDMA/TDMA or any cellular standard, and/or the ISM band). The deobfuscator service 48, however, may be applied to any processor-controlled device operating in the radio-frequency domain and/or the Internet Protocol (IP) domain. The deobfuscator service 48 may be applied to any processor-controlled device utilizing a distributed computing network, such as the Internet (sometimes alternatively known as the “World Wide Web”), an intranet, a local-area network (LAN), and/or a wide-area network (WAN). The deobfuscator service 48 may be applied to any processor-controlled device utilizing power line technologies, in which signals are communicated via electrical wiring. Indeed, the many examples may be applied regardless of physical componentry, physical configuration, or communications standard(s).

Operating environments may utilize any processing component, configuration, or system. For example, the deobfuscator service 48 may be easily adapted to execute by a desktop, mobile, or server central/graphical processing unit 58 or chipset offered by INTEL®, ADVANCED MICRO DEVICES®, ARM®, NVIDIA®, APPLE®, TAIWAN SEMICONDUCTOR MANUFACTURING®, QUALCOMM®, or other manufacturer. The computer system 20 may even use multiple central CPUs/GPUs/cores or chipsets, which could include distributed processors or parallel processors in a single machine or multiple machines. The CPUs/GPUs/cores or chipsets can be used in supporting a virtual processing environment. The CPUs/GPUs/cores or chipsets could include a state machine or logic controller. When any of the CPUs/GPUs/cores or chipsets execute instructions to perform “operations,” this could include the CPUs/GPUs/cores or chipsets performing the operations directly and/or facilitating, directing, or cooperating with another device or component to perform the operations.

The deobfuscator service 48 may use packetized communications. When the computer system 20 communicates (such as via a communications network and/or a cloud computing environment), information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The deobfuscator service 48 may utilize any signaling standard. Computer networks and cloud computing environments may mostly use wired networks to interconnect network members. However, the deobfuscator service 48 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The deobfuscator service 48 may also utilize other standards, such as the I.E.E.E. 802 family of standards, the Industrial, Scientific, and Medical band of the electromagnetic spectrum, BLUETOOTH®, low-power or near-field, and any other standard or value.

The deobfuscator service 48 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for deobfuscating the malware 22 in the nodal content 84, as the above paragraphs explain.

The diagrams, schematics, illustrations, and tables represent conceptual views or processes illustrating examples of scriptive malware deobfuscation. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method that deobfuscates a malware, comprising:
identifying a cmdlet in a nodal content associated with a node of an abstract syntax tree;
identifying a safescript associated with the cmdlet; and
deobfuscating the malware by simulating a runtime execution of the nodal content using the safescript.

2. The method of claim 1, further comprising safescript substituting the cmdlet in the nodal content with the safescript.

3. The method of claim 1, further comprising logging the simulating of the runtime execution.

4. The method of claim 1, wherein the identifying of the safescript further comprises querying an electronic database having a database entry that associates the cmdlet to the safescript.

5. The method of claim 1, wherein the identifying of the safescript further comprises querying an electronic database having database entries that associate different cmdlets to their corresponding safescripts including a database entry of the database entries that associates the cmdlet to the safescript.

6. The method of claim 1, further comprising matching the cmdlet to a text pattern.

7. The method of claim 6, further comprising querying an electronic database having a database entry that associates the text pattern to the safescript.

8. At least one computer system that deobfuscates a malware, comprising:
at least one central processing unit; and
at least one memory device storing instructions that, when executed by the at least one central processing unit, perform operations, the operations comprising:
generating an abstract syntax tree (AST);
identifying a cmdlet associated with a node of the AST;
identifying a safescript associated with the cmdlet; and
generating a nodal output that deobfuscates the malware by simulating a runtime execution using the safescript instead of the cmdlet.

9. The at least one computer system of claim 8, wherein the operations further comprise safescript substituting the cmdlet in the nodal script with the safescript.

10. The at least one computer system of claim 8, wherein the operations further comprise logging the simulating of the runtime execution using the safescript instead of the cmdlet.

11. The at least one computer system of claim 8, wherein the operations further comprise querying an electronic database having a database entry that associates the cmdlet to the safescript.

12. The at least one computer system of claim 8, wherein the operations further comprise querying an electronic database having database entries that associate different cmdlets to their corresponding safescripts including a database entry of the database entries that associates the cmdlet to the safescript.

13. The at least one computer system of claim 8, wherein the operations further comprise matching the cmdlet to a text pattern.

14. The at least one computer system of claim 13, wherein the operations further comprise querying an electronic database having a database entry that associates the text pattern to the safescript.

15. A memory device storing instructions that, when executed by at least one central processing unit, perform operations that deobfuscates a malware, the operations comprising:
generating an abstract syntax tree (AST);
identifying a cmdlet specified by a nodal content associated with a node of the AST;
identifying a safescript by querying an electronic database for the cmdlet, the electronic database having database entries that map different cmdlets to their corresponding safescripts including a database entry that maps the cmdlet to the safescript;
safescript substituting the cmdlet specified by the nodal content with the safescript identified by the querying of the electronic database;
generating a nodal output that deobfuscates the malware by simulating a runtime execution of the nodal content having the safescript substituted therein; and
replacing the nodal content associated with the node of the AST with the nodal output that deobfuscates the malware.

16. The memory device of claim 15, wherein the operations further comprise generating a natural language output explaining the nodal content.

17. The memory device of claim 15, wherein the operations further comprise comparing the nodal content to a cmdlet profile generated by a machine learning model trained using the different cmdlets and their corresponding safescripts.

18. The memory device of claim 17, wherein the operations further comprise generating a cybersecurity prediction based on the comparing of the nodal content to the cmdlet profile.

19. The memory device of claim 15, wherein the operations further comprise determining a safescript substitution count associated with the safescript substituting of the cmdlet with the safescript.

20. The memory device of claim 15, wherein the operations further comprise matching the cmdlet to a text pattern.
